(19) United States
(12) Patent Application Publication
(10) Pub. No.: US 2024/0276441 A1
(43) Pub. Date: Aug. 15, 2024

(54) METHOD FOR DETECTING AND LOCALIZING ACCESS POINTS WITHIN A SPACE

(71) Applicant: VergeSense, Inc., Mountain View, CA (US)

(72) Inventors: Kanav Dhir, Mountain View, CA (US); Kelby Green, Mountain View, CA (US); TJ McConnell, Mountain View, CA (US); Kevin Lloyd, Mountain View, CA (US)

(21) Appl. No.: 18/443,077

(22) Filed: Feb. 15, 2024

Related U.S. Application Data
(60) Provisional application No. 63/445,990, filed on Feb. 15, 2023.
(60) Provisional application No. 63/524,165, filed on Jun. 29, 2023.

(51) Int. Cl. H04W 64/00

(52) U.S. Cl. CPC H04W 64/003

(57) ABSTRACT

One variation of a method includes: detecting a set of radio signals transmitted between a set of computing devices and a set of access points in the space; for each radio signal in the set of radio signals, extracting a pair of unique identifiers representing an initial computing device and an initial access point from the radio signal; storing the pair of unique identifiers in a set of containers; accessing a known position of the wireless sensor; accessing a signal transmission range of an access point based on the set of containers; deriving a signal strength of a radio signal based on the known position and the signal transmission range; in response to the signal strength exceeding a threshold signal strength, deriving a location unit occupied by the access point; and aggregating the location unit into a localization map representing locations of the set of access points in the space.

### CROSS-REFERENCE TO RELATED APPLICATIONS

This Application claims the benefit of U.S. Provisional Application No. 63/445,990, filed on 15 Feb. 2023, and 63/524,165, filed on 29 Jun. 2023, each of which is incorporated in its entirety by this reference.

This Application is also related to U.S. patent application Ser. No. 16/828,676 filed on 24 Mar. 2020, and Ser. No. 16/191,115, filed on 14 Nov. 2018, each of which is incorporated in its entirety by this reference.

### TECHNICAL FIELD

This invention relates generally to the field of workplace monitoring and more specifically to a new and useful method for detecting and localizing access points within a space in the field of workplace monitoring.

### BRIEF DESCRIPTION OF THE FIGURES

FIG. 1 is a flowchart representation of a method;

FIG. 2 is a flowchart representation of one variation of the method; and

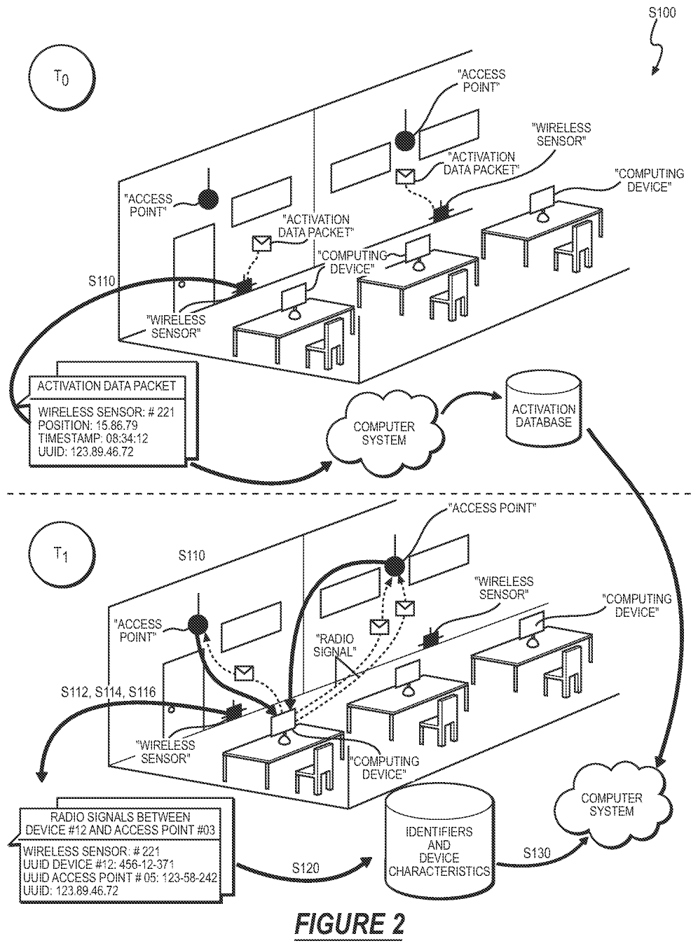

FIG. 3 is a flowchart representation of one variation of the method.

### DESCRIPTION OF THE EMBODIMENTS

The following description of embodiments of the invention is not intended to limit the invention to these embodiments but rather to enable a person skilled in the art to make and use this invention. Variations, configurations, implementations, example implementations, and examples described herein are optional and are not exclusive to the variations, configurations, implementations, example implementations, and examples they describe. The invention described herein can include any and all permutations of these variations, configurations, implementations, example implementations, and examples.

### 1. Method

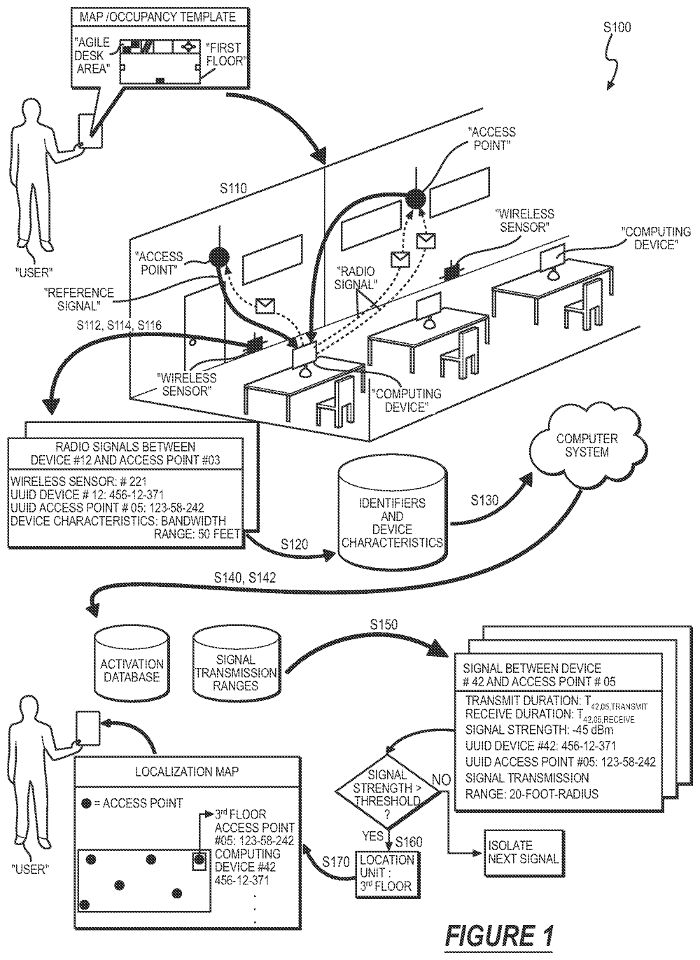

As shown in FIG. 1, a method S100 for detecting occupancy within a space includes, at a first wireless sensor: detecting a set of radio signals transmitted between a set of computing devices and a set of access points arranged in the space in Block S110. The method S100 also includes, for each radio signal in the set of radio signals: extracting a source unique identifier representing an initial computing device, in the set of computing devices, from the radio signal in Block S112; extracting a unique destination identifier representing an access point, in the set of access points, from the radio signal in Block S114; and retrieving a set of device characteristics associated with the initial computing device from the radio signal in Block S116. The method S100 further includes storing source unique identifiers, unique destination identifiers, and sets of device characteristics, extracted from the set of radio signals, in a first set of containers in Block S120.

The method S100 further includes, at a computer system: accessing a known position of the first wireless sensor from an activation database in Block S140; accessing a signal transmission range of a first access point, in the set of access points, based on the first set of containers in Block S142; deriving a first signal strength of a first radio signal, in the set of radio signals, based on the known position of the wireless sensor and the signal transmission range of the first access point in Block S150; in response to the first signal strength exceeding a threshold signal strength, deriving a first location unit occupied by the first access point in Block S160 and defining the first location unit in a localization map representing locations of the set of access points within the space in Block S170.

### 1.1 Variation: Data Packet Frequency+Occupancy States

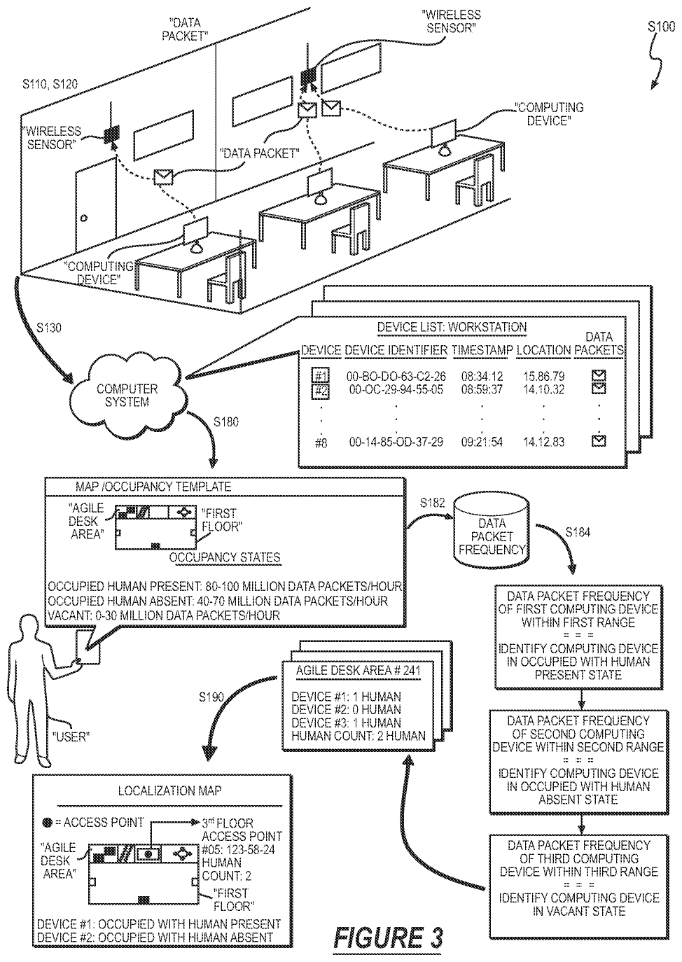

As shown in FIG. 3, one variation of the method S100 includes, at a first wireless sensor: detecting a first set of data packets transmitted by a first computing device at a first time in Block Silo; and detecting a second set of data packets transmitted by a second computing device at the first time in Block S110.

The method S100 further includes: retrieving a map of the space; accessing an occupied with human present state defining a first target frequency range for computing devices in the first work zone in Block S180; accessing an occupied with human absent state annotated with a second target frequency range for computing devices in the first work zone in Block S180; calculating a first data packet frequency of the first set of data packets transmitted by the first computing device in Block S182; in response to the first data packet frequency falling within the first target frequency range, identifying the first computing device in the occupied with human present state in Block S184; calculating a second data packet frequency of the second set of data packets transmitted by the second computing device in Block S182; in response to the second data packet frequency falling within the second target frequency range, identifying the second computing device in the occupied with human absent state in Block S184; and updating the map of the space to indicate the first computing device in the occupied with human present state and the second computing device in the occupied with human absent state within the first work zone in Block S190.

### 1.2 Variation: Localization Map of Access Points

One variation of the method S100 includes, at a wireless sensor, detecting a set of radio signals transmitted between a set of computing devices and a set of access points deployed throughout the space in Block S110. The method S100 further includes, for each radio signal in the set of radio signals: extracting a first unique identifier representing an initial computing device, in the set of computing devices, from the radio signal in Block S112; and extracting a second unique identifier representing an initial access point, in the set of access points, from the radio signal in Block S114. The method S100 further includes associating unique identifiers of the set of access points with the set of computing devices in a first set of containers in Block S120.

The method S100 further includes: accessing a known position of the first wireless sensor in Block S140; accessing a first signal transmission range of a first access point, in the set of access points, based on the first set of containers in Block S142; deriving a first signal strength of a first radio signal, in the set of radio signals, based on the known position and the first signal transmission range in Block S150; and, in response to the first signal strength exceeding a threshold signal strength, deriving a first location unit occupied by the first access point in Block S160 and defining the first location unit in a localization map representing locations of the set of access points within the space in Block S170.

### 2. Applications

Generally, Blocks of the method S100 can be executed by a computer system and a population of wireless sensors deployed throughout an office space (e.g., a workspace): to monitor network traffic (e.g., radio signals, reference signals) between computing devices (e.g., laptops, desktops, mobile phones, tablets) and a population of access points (e.g., routers); to extract data from radio signals transmitted between these computing devices and the population of access points; to transform a known position of the wireless sensor and a signal transmission range of each access point—such as a 50-foot signal transmission radius, X-, Y-, and Z-axes signal ranges, or a latitude, longitude, and an altitude—into a location unit (e.g., a floor level, a conference number of a building) representing the access point; to derive metrics and insights, such as a localization map of location units representing the population of access points, from these radio signals; and to present these metrics and insights to a user (e.g., an office manager, an administrator) affiliated with the office space, thereby enabling the user to achieve and maintain awareness of positions of computing devices—relative to a location unit within the office space over a period of time—with no or minimal exposure of private (e.g., employee, “worker”) information to the user or other entities.

### 2.1 Localization of Access Points

More specifically, the computer system can implement regression, machine learning, and/or other computer vision techniques to develop (or “learn”) access point clustering models for common groups of computing devices within the office space—such as groups of similar or different computing devices (e.g., laptops, desktops, mobile phones, tablets) frequently transmitting radio signals to a set of access points—to predict a location unit (e.g., a floor level of a building, a conference room identifier) occupied by a cluster of access points associated with the common group of computing devices. The computer system can execute these access point clustering models to autonomously link a predicted location unit occupied by a cluster of access points to an analogous (e.g., similar, matching) known location unit (e.g., a floor level of a building, a conference room identifier) derived by the computer system. In particular, the computer system can execute these methods and techniques to predict a “location unit” (e.g., an area or volume) occupied by one or a group of access points, such as a field, wing, floor, conference room identifier, cluster of rooms, or particular room within a building, facility, or campus.

Additionally or alternatively, the computer system can execute these access point clustering models to autonomously link a particular access point and a corresponding common group of computing devices with a known location unit (e.g., a floor, a conference room identifier) from an existing digital floorplan of the facility provided by the user. For example, in response to detecting a match between a known floor level from the existing digital floorplan and a predicted floor level of the common group of computing devices, the computer system can: aggregate the common group of computing devices, the floor level, and the particular access point into the localization map of access points; and reinforce the access point clustering model. In another example, in response to detecting a difference between the known floor level from the existing digital floorplan and the predicted floor level of the common group of computing devices, the computer system can retrain and/or update the access point clustering model for future time periods.

### 2.2 Device Classification

The computer system, in conjunction with the population of wireless sensors, can further execute Blocks of the method S100: to monitor network traffic (e.g., radio signals) from computing devices (e.g., laptops, mobile phones, tablets, desktops, printers) within the office space; to generate a device list for the office space annotated with data packets extracted from radio signals, locations of computing devices, timestamps of radio signal transmission, and device identifiers corresponding to a computing device type; to interpret computing devices as active and/or inactive; to derive metrics and insights (e.g., human occupancy, human count, human absence, human presence) for particular work zones (e.g., conference room, agile work environment, hallway, lounge, reception area) within the office space from data packet frequencies of these computing devices; and to present these metrics and insights to a user (e.g., administrator or manager affiliated with the office space).

Furthermore, the computer system can implement regression, machine learning, and/or other computer vision techniques to develop device classification models for common device groupings within the office space—such as groups of similar or different device types as a function of time of day, location in the office space, data packet frequency, bandwidth, and/or signal strength—that indicate or correspond to an active device associated with human presence and/or an inactive device type associated with human absence. The computer system can also: generate notifications indicating a device classification of each device in a common group of a device type; and automatically generate prompts for the user to confirm these device classifications.

The computer system can further execute Blocks of the method S100 to: collect user feedback responsive to these prompts; and reinforce an active device classification model or an inactive device classification model responsive to positive feedback from the user. Additionally or alternatively, responsive to negative feedback from the user, the computer system can retrain and/or update the active device classification model or the inactive device classification model.

### 2.2 Human Occupancy

Accordingly, the computer system can execute the active device classification model and the inactive device classification model to identify computing devices as active and/or inactive within a particular work zone in the office space. The computer system can access an occupancy template defining a set of occupancy states—such as an occupied with human present state, an occupied with human absent state, or a vacant state—for computing devices within the particular work zone. The computer system can further identify a known human count, from the occupancy template, corresponding to each active and/or inactive computing device to derive human occupancy, such as a total human count, for this particular work zone within the office space.

The computer system can also present human occupancy for the work zone to a user via a user portal and thereby enable the user to timely review human occupancy of the work zone, avoid a manual check of the work zone, and generate informed decisions regarding occupancy usage of the work zone.

The method S100 is described herein as executed by a computer system in conjunction with a population of wireless sensors to: detect radio signals; track radio signals transmitted between computing devices and access points; derive location units of these access points and computing devices; detect device types; track device types; derive human occupancy within a work zone; and generate insights related to location units of these access points and computing devices within an office space. However, Blocks of the method S100 can additionally or alternatively be executed by the population of wireless sensors, by a local computer system, by a network of wireless sensors, and/or by a network of sensor blocks, to: detect radio signals; track radio signals transmitted between computing devices and access points; derive location units of these access points and computing devices; detect device types; track device types; derive human occupancy within a work zone and generate insights related to location units of these computing devices and access points within an industrial or educational space.

### 3. Terms

Generally, each wireless sensor, in a population of wireless sensors (e.g., Wi-Fi routers, wireless monitors, wireless routers, wireless access points) deployed within a facility (e.g., office space), can execute wireless local area network protocols (or “WLAN” protocols) according to wireless computer networking standards (e.g., IEEE 802.11) in conjunction with computing devices (e.g., Wi-Fi enabled devices) within a threshold distance of a wireless sensor. Each computing device can wirelessly connect to the network settings of the facility and transmit radio signals to a computer system (e.g., remote computer system, remote server, cloud) via a wireless sensor in the population of wireless sensors. The radio signals can include probe frames sent from each computing device to search for nearby wireless networks.

Additionally or alternatively, these radio signals can include data (or “data packets”) configured to store a first encrypted unique identifier (e.g., an UUID, an IP address, a MAC address, other wireless address) for a start node (e.g., computing device, printer, wireless sensor) transmitting the radio signal and a second encrypted unique identifier (e.g., an UUID, an IP address, a MAC address, other wireless address) for a target node (e.g., an access point, a computing device, a wireless sensor, a printer).

Furthermore, each wireless sensor can: capture network traffic (e.g., record radio signals) from each computing device connected to the network settings of the facility; extract data packets from each radio signal; write insights (e.g., probe frames, ping frequency) to these data packets; and transmit these radio signals and/or data packets to a computer system.

Accordingly, the computer system can then monitor target conditions of data packets (e.g., data packet frequency, received signal strength indicator, bandwidth, time of day, location), derive models for these target conditions, and execute these models to derive occupancy metrics and insights of an area of interest (or “work zone”) within the space and/or usage of the work zone.

Alternatively, the computer system can derive models for these target conditions and execute these models to predict a “location unit” (e.g., an area or volume) occupied by one or a group of access points, such as a field, wing, floor, conference room, workstation, cluster of rooms, or particular room within a building, facility, or campus (e.g., a floor level of a building, a conference room identifier) of each access point within the space. Further, the computer system can: extract data from radio signals transmitted between computing devices and the population of access points; and transform a known position of the wireless sensor and a signal transmission range of each access point—such as a 50-foot signal transmission radius, X-, Y-, and Z-axes signal ranges, or a latitude, longitude, and an altitude—into a location unit and define each location unit in a localization map representing locations of access points within the space.

### 4. Wireless Sensor

A wireless sensor (e.g., Wi-Fi router, wireless monitor, wireless router, wireless access point) can include: a radio configured to receive and/or transmit radio signals over a wireless network within a facility (e.g., agile work environment, office space, workspace); a processor configured to extract data packets from these wireless signals recorded by the radio; a device-detection module configured to retrieve unique identifiers (e.g., an UUID, a MAC address, an IP address, or other wireless address) of each computing device (e.g., mobile phone, laptop, tablet, desktop, printer) located within a threshold distance of the wireless sensor from these data packets; a wireless communication module configured to wirelessly transmit these data packets extracted to a computer system; a battery configured to power the radio, the processor, the device detection module, and the wireless communication module over an extended duration of time (e.g., one year, five years); and an housing configured to contain the radio, the processor, the device detection module, the wireless communication module, and the battery and configured to mount to a surface within a work zone within the facility (e.g., a conference table within a conference room, a cluster of agile desks in an agile work environment). The wireless sensor can also include a solar cell or other energy harvester configured to recharge the battery.

The radio can include: a wireless networking transceiver that supports full-duplex, digital transmission of radio signals with other computing devices (e.g., mobile phones, laptops, tablets, desktops, printers) proximal (e.g., within the threshold distance of) the wireless sensor; a geospatial position sensor configured to detect the geospatial location of the radio; and a local memory. Thus, in this implementation, the radio can receive radio signals in digital format over the wireless networking transceiver and output data packets—extracted from these radio signals via the processor—to the wireless communication module to transmit to a computer system (e.g., remote server).

The processor can locally execute Blocks of the method S100, as described above and below, to selectively wake responsive to an input of the radio (e.g., wireless signal), to write various insights extracted from the wireless signal, and to then queue the wireless communication module to broadcast these insights to a nearby gateway for distribution to the computer system when these insights exhibit certain target conditions or represent certain changes within the facility.

In one variation, the radio, battery, processor, device detection module, and wireless communication module, etc. can be arranged within a single housing configured to install on a flat surface—such as by adhering or mechanically fastening to a wall or ceiling within a work zone within the facility.

In another variation, the wireless sensor can include an electrical plug arranged on the housing and configured to connect to an electrical wall outlet within a work zone within the facility (e.g., a conference table within a conference room, a cluster of agile desks in an agile work environment, a table within a cafeteria) to power the radio. In this variation, the radio, processor, device detection module, and wireless communication module etc. can be arranged within a single housing configured to electrically couple to an electrical outlet on a flat surface (e.g., wall) within the work zone within the facility.

However, this “standalone,” “mobile” wireless sensor can define any other form and can mount to a surface in any other way.

### 4.1 Wired Power & Communications

In one variation, the wireless sensor additionally or alternatively includes a receptacle or plug configured to connect to an external power supply within the facility—such as a power-over-Ethernet cable—and sources power for the radio, processor, etc. from this external power supply. In this variation, the wireless sensor can additionally or alternatively transmit data packets—extracted from radio signals recorded by the radio—to the computer system via this wired connection (i.e., rather than wirelessly transmitting these data packets to a local gateway) according to a predefined data packet threshold/filter.

### 4.2 Data Sampling

Generally, during a sampling period (e.g., once per ten-minute interval, once per one-hour interval when the radio records a radio signal), each wireless sensor can monitor network traffic (e.g., radio signals) between computing devices connected to the network settings of the facility, extract data packets from these radio signals, and transmit these data packets to the computer system.

More specifically, for each sampling period, the wireless sensor can: extract data packets from each radio signal, extract a geospatial location of each radio signal, and extract a device identifier associated with each radio signal. Furthermore, the wireless sensor can annotate theses data packets with a timestamp, a location, and the device identifier (e.g., an UUID, a MAC address, an IP address, or other wireless address) pertaining to a computing device and transmit these annotated data packets to the computer system, such as via a wired or wireless connection (e.g., via the local gateway).

### 5. Local Gateway

A local gateway can receive data packets transmitted from wireless sensors nearby via a wireless communication protocol or via a local ad hoc wireless network; and to pass these data packets to the computer system, such as over a computer network or a long-range wireless communication protocol. For example, a gateway installed near and connected to a wall power outlet, can pass data received from a nearby wireless sensor to the computer system in (near) real-time.

Furthermore, multiple gateways installed throughout the facility can interface with many wireless sensors installed nearby (e.g., within a threshold distance of) the local gateway to collect data from these wireless sensors and to return these data to the computer system.

### 6. Computer System

The computer system (e.g., a remote computer system, a remote server) can receive radio signals, unique identifiers, and device characteristics between a client device (e.g., a computing device connected to the wireless network of the office space) and a set of access points directly from the population of wireless sensors or from one or more gateways installed in the facility. The computer system can then: monitor network traffic for groups of common computing devices; implement regression, machine learning, and/or other computer vision techniques to develop access point clustering models for (or “learn”) common access point groupings within the office space; apply these access point clustering models to assign a location unit (e.g., a floor level, a conference room identifier, or a workstation identifier associated with the facility) to a cluster of access points; assign this location unit to a set of computing devices associated with the cluster of access points (e.g., transmitting radio signals to the cluster of access points); and derive metrics and insights such as a map of access point locations within the office space; execute actions (e.g., generate notifications) for these metrics and insights; and serve these notifications to a user—such as an administrator or manager affiliated with the office space—via a user portal.

In one variation, the computer system can receive device lists—annotated with data packets extracted from radio signals, locations of computing devices, timestamps of radio signal transmission, and device identifiers corresponding to a computing device type during a particular time period—directly from the population of wireless sensors or from one or more gateways installed in the facility. The computer system can then: monitor network traffic for groups of common device types; implement regression, machine learning, and/or other computer vision techniques to develop device classification models for common device groupings within the office space; apply these device classification models to interpret computing devices in a group of a common device type as active and/or inactive; derive metrics and insights (e.g., human occupancy, human count, human absence, human presence) within the office space; generate notifications for these metrics and insights; and serve these notifications to the user via the user portal.

### 6.1 Data Aggregation

In one variation, the computer system can collect an annotated device list with time stamps and a unique device identifier (e.g., an UUID, a MAC address, an IP address, or other wireless address) from the populations of wireless sensors deployed in the space over a period of time (e.g., one day, one week, one month). Then, the remote computer system can aggregate these annotated device lists for each wireless sensor into a device identifier database and/or an activation database, as further describes below.

### 7. Installation

Generally, a user (e.g., administrator, installer, or manager) may install each wireless sensor in the population of wireless sensors within the office space via a cellular connection to establish a network connection (e.g., a Wi-Fi connection) with the facility and to achieve activation status.

In one implementation, the user may install each wireless sensor in the population of wireless sensors within the space and, upon installation, each wireless sensor can transmit an activation data packet labeled with a location, a timestamp, and an unique identifier (e.g., an UUID, an IP address, a MAC address, other wireless address) of the wireless sensor to the computer system. The computer system can then populate a list of locally-activated wireless sensors deployed within the facility.

In one variation, the user may establish an initial connection between the network settings of the facility and a wireless sensor, in the population of wireless sensors, located within an office space. The wireless sensor can then: generate an activation data packet; annotate the activation data packet with a location of the wireless sensor, a timestamp of activation, and a unique identifier (e.g., an IP address); and transmit the activation data packet to the computer system. The computer system can receive the activation data packet from the wireless sensor and compile the annotated activation data packet into a list of locally-activated wireless sensors deployed within the office space.

Furthermore, the user may implement these methods and techniques for each other wireless sensor in the population of wireless sensors deployed within the facility to activate all wireless sensors and establish network connectivity with the facility. Each other wireless sensor can also implement similar methods and techniques to transmit a data packet to the computer system and/or local gateway to populate the list of locally-activated wireless sensors in the facility.

### 7. Activation Database

In one variation, the user may establish an initial connection between the network settings of the facility and each wireless sensor deployed in the space. Each wireless sensor can then: generate an activation data packet; annotate the activation data packet with a position of the wireless sensor, a timestamp of activation, and a unique identifier (e.g., an IP address); and transmit the activation data packet to the computer system. The computer system can receive the activation data packet from each wireless sensor and compile annotated activation data packets into an activation database representing locally-activated wireless sensors deployed within the facility.

### 8. Radio Signal Detection

Generally, after installation, each wireless sensor can detect a set of radio signals transmitted between each client device—such as a computing device connected to the wireless network of the facility—and each access point deployed throughout the space. Each wireless sensor can then offload the set of radio signals to the computer system in Block S130.

More specifically, each wireless sensor can detect a set of radio signals transmitted between a source client device and a set of destination access points within a threshold distance of the wireless sensor and extract data from this set of radio signals. Each wireless sensor can then offload this set of radio signals and these data to the computer system to predict a location unit (e.g., an area or volume) of one access point or the set of destination access points within the space, such as a floor, field, wing, conference room, workstation, a cluster of rooms, or a particular room of a facility.

In one implementation, each wireless sensor can: detect a set of radio signals transmitted between a source client device and a set of destination access points within a threshold distance (e.g., ten feet, fifty feet, one hundred feet) of the wireless sensor; and extract data packets from these radio signals containing a first unique identifier (e.g., an UUID, a MAC address, an IP address, or other wireless address) of a source client device (e.g., a laptop, a desktop, a tablet, a mobile phone) located within the threshold distance of the wireless sensor, a second unique identifier of a destination access point (e.g., a WLAN hardware device for Wi-Fi enabled devices), and client device characteristics (e.g., data rates, quality service levels, a bandwidth range). The computer system can then: store unique identifiers and sets of device characteristics of the set of access points in a set of containers; and transmit the set of containers to the computer system in Block S130.

### 8.1 First Location Unit: Known Position+Signal Transmission Range

In one variation, once the computer system receives the set of containers from a wireless sensor, the computer system can: access a signal transmission range—such as a 50-foot signal transmission radius, an X-axis signal range, Y-axis signal range, and Z-axis signal range, or a latitude, longitude, and altitude defined by a user in the map of the space—of a first access point corresponding to data stored in the set of containers; and access a known position of the wireless sensor within the space from the device identifier database and/or the activation database. The computer system can then derive a signal strength from the known position of the wireless sensor and transform the signal strength and the signal transmission range of an access point—associated with the set of radio signals—into a location unit (e.g., a floor level, a conference room identifier) occupied by the access point. Accordingly, the computer system can identify corresponding computing devices (e.g., a client device transmitting a reference signal to each access point) linked to a particular access point with this location unit.

In one implementation, the computer system can: receive an activation data packet, generated by a first wireless sensor, annotated with an initial position of the first wireless sensor, a timestamp of activation, and an initial unique identifier; and compile the activation data packet into an activation database—representing activation of a population of wireless sensors and ranked by timestamps. The computer system can then access the known position of the first wireless sensor by: extracting a first unique identifier representing the first wireless sensor from the set of radio signals; and, in response to the first unique identifier corresponding to the initial unique identifier in the activation database, retrieve the initial position of the first wireless sensor from the activation data packet. The computer system can derive the first signal strength of a first radio signal responsive to the initial position intersecting the signal transmission range, such as: a 50-foot signal transmission radius; an X-axis signal range, Y-axis signal range, and Z-axis signal range; or a latitude, longitude, and altitude.

For example, the computer system can: receive a set of radio signals transmitted between a laptop and a set of (e.g., three) access points, from a wireless sensor deployed in an office space; isolate a first radio signal between the laptop and a first access point in the set of (e.g., three) access points; retrieve an activation data packet for the wireless sensor from the activation database; extract a known position, such as 14.10.32 on the second floor of the facility, of the wireless sensor from the activation data packet; access a signal transmission range, such as a 20-foot signal transmission range defined by a user in the map of the space, corresponding to the first access point; and, in response to the known position of the wireless sensor intersecting the 20-foot signal transmission range of the first access point, derive a first signal strength, such as −80 decibel-milliwatts. Then, in response to detecting the first signal strength, such as −80 decibel-milliwatts, falling below a threshold signal strength, such as −65 decibel-milliwatts, the computer system can: isolate a second radio signal between the laptop and a second access point in the set of (e.g., three) access points; access a signal transmission range, such as a 50-foot signal transmission range, corresponding to the second access point; and, in response to the known position of the wireless sensor intersecting the 50-foot signal transmission range of the second access point, derive a second signal strength, such as −45 decibel-milliwatts.

Additionally, in response to detecting the second signal strength, such as −45 decibel-milliwatts, exceeding the threshold signal strength, such as −65 decibel-milliwatts, the computer system can predict a first location unit, such as a second floor of the facility, for the second access point and the laptop. Thus, the computer system can link (or derive a correlation between) the known position of the wireless sensor, the signal transmission range of the second access point, and the signal strength of a radio signal to predict a location unit occupied by the second access point and the corresponding laptop.

Furthermore, the computer system can store this first location unit as a known location unit with the set of unique identifiers in a container, in a set of containers, representing the second access point. The computer system can repeat methods and techniques described above for each other wireless sensor deployed throughout the office space and store known locations for other access points in the set of containers.

Alternatively, the computer system can identify this first location unit as a known location unit and represent the first location unit occupied by the second access point with the set of unique identifiers in a localization map representing locations of the set of access points in the space.

### 9. Modeling: Access Point Clustering

In one implementation, the computer system can implement machine learning, regression, and/or other computer vision techniques to derive (or “learn”) access point clustering models for groups of computing devices (e.g., laptops, desktops, tablets, mobile phones) transmitting radio signals to a set of access points deployed throughout the facility.

In one variation, the computer system can: track groups of computing devices transmitting radio signals to a set of access points within the office space over a period of time (e.g., one day, one week); detect a common group of computing devices transmitting radio signals to each access point in the set of access points within this period of time; and derive access point clustering models for patterns of the common groups of computing devices.

For example, the computer system can: detect a common group of computing devices (e.g., a laptop, a desktop monitor, a mobile phone) transmitting radio signals to a set of (e.g., two) access points within a threshold distance of a wireless sensor and repeating at a high frequency during a given time period (e.g., 8 AM to 11 AM); track the frequency of occurrence of the common group of computing devices (e.g., a laptop, a desktop monitor, a mobile phone) transmitting radio signals to each access point in the set of access points during future time periods; define a pattern according to the frequency of occurrence of the common group of computing devices detected during future time periods; and generate an access point clustering model for the pattern of the common group of computing devices for the office space.

The computer system can repeat the methods and techniques described above for each other common group of computing devices and for each other set of access points in the population of access points deployed throughout the facility to develop access point clustering models for the office space.

Therefore, the computer system can monitor radio signal transmission between computing devices and the population of access points deployed throughout the office space to detect patterns of common groups of computing devices and derive access point clustering models.

### 10. Autonomous Localization: Next Location Unit+Access Point Cluster

In one implementation, the computer system can execute these access point clustering models to autonomously link a cluster of access points relative a known location unit (e.g., a floor level, a conference room identifier) occupied by an access point. Accordingly, the computer system can link each client device transmitting radio signals with an access point in this cluster and thereby, assign a location unit to each client device.

In one variation, the computer system can: execute the access point clustering model to isolate a cluster of access points; retrieve a common group of computing devices transmitting radio signals to this cluster of access points; extract a set of unique identifiers representing the common group of computing devices; scan the set of containers storing known location units occupied by access points for a set of known unique identifiers analogous to (e.g., similar to, matching) the set of unique identifiers representing the common group of computing devices; in response to detecting a set of known unique identifiers analogous to the set of unique identifiers representing the common group of computing devices, characterize a difference between the known set of unique identifiers and the set of unique identifiers representing the common group of computing devices; and assign a known location unit to the cluster of access points corresponding to the difference between the set of known unique identifiers and the set of unique identifiers.

For example, the computer system can: execute the access point clustering model to isolate a cluster of access points; retrieve a common group of laptops transmitting radio signals to this cluster of access points; extract a set of MAC addresses representing the common group of laptops; scan the set of containers storing known location units occupied by access points for a set of known MAC addresses analogous to the set of MAC addresses corresponding to the common group of laptops; and, in response to detecting a set of known MAC addresses analogous to the set of MAC addresses representing the common group of laptops, characterize a difference between the known set of MAC addresses and the set of MAC addresses representing the common group of laptops. Then, in response to the difference between the known set of MAC addresses and the set of MAC addresses representing the common group of laptops falling below a difference threshold, and, in response to the signal transmission range corresponding to a target signal transmission range, the computer system can assign the known location unit representing the known set of MAC addresses to the cluster of access points.

The computer system can then repeat methods and techniques described above for each other cluster of access points, for each other common group of computing devices, and for each other known location unit and aggregate these location units into a localization map of the population of access points for the office space.

### 10.1 Autonomous Localization: Existing Digital Floor Plan+Location Unit

In one variation, the computer system can execute the access point clustering model to autonomously link the common group of computing devices and the particular access point with a location unit (e.g., a floor, a conference room identifier) from an existing digital floorplan or map of the facility.

Furthermore, the computer system can prompt a user to provide an existing digital floorplan of the facility labeled with location units (e.g., floor levels, conference room identifiers, reception areas, lounge areas) and/or signal transmission geometries. The computer system can then execute the access point clustering models to link the common group of computing devices, associated with a particular access point, with a location unit in the existing digital floorplan of the facility.

In one example, an office manager may request a location unit occupied by a particular access point and the associated common group of computing devices via the user portal. In this example, the computer system: interfaces with the user portal to access an existing digital floorplan of a building (e.g., an office space) labeled with areas representing floor levels and conference room identifiers defined by an office manager; and compares a known floor level, such as a second floor of the building, from the existing digital floorplan of the building and the predicted floor level of the common group of computing devices from the access point clustering model. Then, in response to detecting a match between the known floor level from the existing digital floorplan and the predicted floor level of the common group of computing devices, the computer system: aggregates the common group of computing devices, the floor level, and the particular access point in a localization map representing locations of access points; and reinforces the access point clustering model.

Alternatively, in response to detecting a difference between the known floor level, such as a second floor of the building, from the existing digital floorplan and the predicted floor level of the common group of computing devices such as a third floor of the building, the computer system retrains and/or updates the access point clustering model for future time periods. Additionally, the computer system can generate a notification indicating the floor level of the common group of computing devices associated with the particular access point; and transmit the notification to the office manager via the user portal.

In another example, an administrator of an educational facility, such as a campus, may request a location unit occupied by a particular access point via the user portal. In this example, the computer system interfaces with the user portal to access an existing digital floorplan of the campus annotated with floor levels, classroom numbers, and signal transmission geometries and implements methods and techniques described above to predict a first location unit occupied by the particular access point. The computer system then: isolates a known location unit corresponding to an agile desk area in the floor plan of the campus; and, in response to the first location unit corresponding to the known location unit in the floor plan of the educational facility and in response to the first signal transmission range corresponding to a target signal transmission range associated with the agile desk area, populates the agile desk area in the floor plan of the campus with the first location unit to generate a localization map representing locations of access points.

Therefore, the computer system can interface with the user portal to retrieve an existing digital floorplan in order to identify a location unit (e.g., an area or volume) for a common group of computing devices, a particular access point, or a group of access points, within the space such as a floor level, conference room identifier, wing or workstation identifier. Further, the computer system can reinforce and/or retrain the access point clustering model based on a known location unit from the existing digital floorplan and generate notifications indicating the location unit and thereby, enable a user to make informed decisions regarding the space.

### 10.2 Localization Map

Furthermore, the computer system can aggregate location units of the population of access points and a corresponding set of computing devices (e.g., a set of computing devices transmitting radio signals to each access point) for each access point into a localization map of the population of access points for the office space. The computer system can then predict a location unit occupied by future computing devices associated with each access point in the population of access points deployed throughout the facility according to the localization map.

In one variation, the computer system can implement methods and techniques described above to receive unique identifiers and a set of device characteristics between each client device transmitting radio signals to a set of access points, from the population of wireless sensors and to predict a location unit occupied by each access point in the set of access points. The computer system can then: aggregate the location unit occupied by each access point into a localization map of the population of access points for the office space; select a particular access point from the set of access points; scan the localization map for a known access point analogous to a particular access point in the set of access points; detect a known location unit representing a known access point analogous to the particular access point within the localization map; and identify the particular access point as the known access point with the known location unit according to the localization map.

For example, the wireless sensor can: detect a set of radio signals transmitted between a source client device (e.g., a laptop) and a set of destination access points (e.g., routers) within a building; extract a first unique identifier (e.g., a MAC address) from a first radio signal representing the source computing device (e.g., a laptop); extract a second unique identifier (e.g., a MAC address) from the first radio signal representing a first destination access point (e.g., a router); and transmit the first unique identifier and the second unique identifier to the computer system. The computer system can repeat similar methods and techniques for each other radio signal and for each other destination access point (e.g., a router) and transmit a set of unique identifiers for each radio signal to the computer system to generate a localization map of the population of access points.

The computer system can then implement methods and techniques described above to predict a location unit occupied by the source client device (e.g., a laptop) and each destination access point (e.g., a router); aggregate the location unit occupied by each access point into a localization map of the population of access points for the office space; and annotate each location unit representing an access point with a set of unique identifiers and a set of device characteristics representing each client device associated with this access point. The computer system can: receive a set of unique identifiers representing a client device and a destination access point; access the localization map of access points; and scan the localization map of access points for the unique identifier representing the destination access point. Then, in response to detecting a known unique identifier of an access point in the localization map analogous to (e.g., similar to, matching) the unique identifier representing the destination access point, the computer system can: identify the known access point as the destination access point (e.g., a router) within the localization map; annotate the known location unit, occupied by the destination access point, with the unique identifier representing the destination access point within the localization map; highlight the known location unit and the destination access point within the localization map; and serve the localization map of access points annotated with computing devices to a user (e.g., an office manager, an administrator) affiliated with the office space.

Therefore, the computer system can generate a localization map for the office space and present this localization map to a user, thereby enabling the user to review usage of the space and to make informed decisions regarding the space.

### 11. Variation: Ranging Localization+Reference Signal Detection

In one variation, each wireless sensor can detect a set of reference signals between a source client device and a set of destination access points within the threshold distance of the wireless sensor and record transmit and receive durations (e.g., time of arrival receipts) for these set of reference signals. Each wireless sensor can then offload this set of reference signals and transmit and receive durations to the computer system to predict a location unit (e.g., a floor level, a conference room identifier, a workstation identifier) of an access point within the office space.

In one implementation, each wireless sensor can: detect a set of reference signals between a particular client device, such as a source device, and a set of access points, such as a set of destination devices; record transmit durations at the particular client device for these reference signals; and record receive durations, such as time of arrival receipts, at the set of access points for these reference signals.

In one variation, each wireless sensor can: detect a set of reference signals between a set of computing devices, such as a set of client devices, and the set of access points such as a set of destination devices, within a threshold distance of the first wireless sensor (e.g., ten feet, fifty feet, one hundred feet). Each wireless sensor can then: record transmit durations at each client device for these reference signals; and record receive durations, such as time of arrival receipts, at each access point for these reference signals; store these transmit durations and receive durations of the set of reference signals in a set of containers; and transmit the set of containers to the computer system in order to predict location units of other access points in the space.

For example, a wireless sensor can: detect a first reference signal between a source device (e.g., a desktop monitor) and a set of destination access points within a threshold distance (e.g., 30 feet) of the wireless sensor within the office space; record a first transmit duration for the first reference signal between the desktop monitor and a first destination access point; record a first receive duration for the first reference signal between the desktop monitor and the first destination access point; and store the first transmit duration and the first receive duration in a first container. Then, the wireless sensor can: detect a second reference signal between the desktop monitor and the set of destination access points within the threshold distance (e.g., 30 feet); record a second transmit duration for the second reference signal between the desktop monitor and the second destination access point; record a second receive duration for the second reference signal between the desktop monitor and the second destination access point; store the second transmit duration and the second receive duration in a second container; and transmit the first container and the second container to the computer system.

Furthermore, each wireless sensor can then transmit the set of reference signals, transmit durations, and receive durations of these reference signals to the computer system to extract metrics such as signal strength and/or a location unit occupied by computing devices and access points, as further described below.

### 11.1 First Location Unit: Signal Strength+Signal Transmission Range

Once the computer system receives a set of reference signals from each wireless sensor deployed in the office space, the computer system can then transform these reference signals into a location unit occupied by each access point. Accordingly, the computer system can identify corresponding computing devices (e.g., a client device transmitting a reference signal to each access point) linked to a particular access point with this location unit.

In one implementation, the computer system can: receive a set of reference signals between a client device and a set of access points, from a wireless sensor deployed in the office space; isolate a first reference signal between a client device and a first access point; transform the transmit and receive durations of the first reference signal into a first distance between the client device and the first access point; derive a first signal strength, such as a received signal strength indicator value, inversely proportional to the first distance; access a signal transmission range—such as an X-axis signal range, a Y-axis signal range, and a Z-axis signal range—corresponding to the first access point; and predict a location unit (e.g., a floor level, a conference room identifier, a workstation identifier) for the first access point and the corresponding client device, according to the first signal strength and the signal transmission range.

For example, the computer system can: receive a set of reference signals between a laptop and a set of (e.g., three) access points, from a wireless sensor deployed in an agile work environment; isolate a first reference signal between the laptop and a first access point in the set of access points; transform the transmit and receive durations of the first reference signal into a first distance (e.g., 10 meters, 33 feet) between the client device and the first access point; derive a first signal strength (e.g., 30 dBm, 1 Watt) based on the first distance; and access a signal transmission range, such as a 50-foot signal transmission radius, corresponding to the first access point. Then, in response to detecting the first signal strength (e.g., 30 dBm, 1 Watt) exceeding a threshold signal strength, such as 25 dBm, and in response to the signal transmission range corresponding to a target signal transmission range, such as a 50-foot signal transmission radius, the computer system can predict a first location unit, such as a fourth floor of the facility in the agile work environment, occupied by the first access point and the corresponding client device.

Alternatively, in response to the first signal strength falling below the threshold signal strength, such as 25 dBm, the computer system can: isolate a second reference signal, in the set of reference signals; transform a second transmit duration and a second receive duration for the second reference signal into a second distance between the first access point and the corresponding client device; derive a second signal strength inversely proportional to the second distance; and, in response to the second signal strength exceeding a threshold signal strength and in response to the second signal transmission range corresponding to the target signal transmission range, predict a second location unit occupied by the first access point.

Thus, the computer system can transform signal strength and signal transmission range of an access point into a predicted location unit (e.g., a floor level, a conference room identifier, a workstation identifier) of an access point within the space. The computer system can then implement methods and techniques described above to develop access point clustering models to predict location units of other access points relative to the known location unit occupied by the first access point.

### 12. Variation: Autonomous Detection+Human Occupancy

In one variation, the computer system can execute Blocks of the method S100 in conjunction with the set of wireless sensors: to monitor network traffic (e.g., radio signals) from computing devices (e.g., laptops, mobile phones, tablets, desktops, printers) within the office space; to generate a device list for the office space annotated with data packets extracted from radio signals, locations of computing devices, timestamps of radio signal transmission, and device identifiers corresponding to a computing device type; to interpret computing devices as active and/or inactive; and to derive metrics and insights (e.g., human occupancy, human count, human absence, human presence) for particular work zones (e.g., a conference room, an agile work environment, a hallway, a lounge, a reception area) within the office space according to data packet frequencies of these computing devices.

Furthermore, the computer system can present these metrics and insights to a user (e.g., administrator or manager affiliated with the office space), thereby enabling the user to achieve and maintain awareness of human occupancy in the office space and occupancy usage of the office space over time with no or minimal exposure of private employee (or “worker”) information to the user or other entities.

### 12.1 Occupancy Template

Generally, the computer system can access a set of occupancy templates, each occupancy template associated with a work zone within the office space and defining a set of occupancy conditions or occupancy states (e.g., an occupied with human present state, an occupied with human absent state, a vacant state) for computing devices in the work zone. Furthermore, the computer system can receive, via the user portal, a set of occupancy templates (or “policies”) from a user (e.g., administrator or manager affiliated with the office space). Alternatively, the computer system can generate an occupancy template for a particular work zone (e.g., conference room, agile work environment, hallway, lounge, reception area) over time upon deployment within the space. More specifically, the occupancy template defines specific computing devices or conditional arrangements of computing devices (e.g., open position, closed position) such as—a computing device characterized by a data packet frequency greater than and/or less than a threshold data packet frequency—that constitutes occupancy or vacancy in the work zone.

Furthermore, the computer system can interface with the user portal to access a map of the space defining a set of occupancy conditions for computing devices in each work zone of the space. The user may additionally define a target data packet frequency range for each work zone, or the computer system can define a target frequency range over a period of time upon deployment in the space. In one example, the computer system interfaces with the user portal to retrieve a map of the space; an occupied with human present state annotated with a first target frequency range for computing devices in each work zone; an occupied with human absent state annotated with a second target frequency range for computing devices in each work zone; and a vacant state associated with a third target frequency range for computing devices in each work zone.

In another example, the computer system: interfaces with the user portal to retrieve a map of the space; access an occupied with human present state annotated with a first target frequency range and a corresponding human count, such as a human count of one, for computing devices in each work zone; access an occupied with human absent state annotated with a second target frequency range and a corresponding human count, such as a human count of one, for computing devices in each work zone; and a third condition of a vacant state associated with a third target frequency range and a corresponding human count, such as a human count of zero, for computing devices in each work zone.

In one implementation, the computer system can transform the occupancy policy defined by the user into occupancy logic. In one example, the computer system accesses an occupancy template associated with a conference room that designates identification of each laptop with a data packet frequency greater than the threshold data packet frequency as occupied with human present state and a corresponding human count of one. In another example, the computer system accesses an occupancy template associated with an agile work environment that designates identification of each laptop with a data packet frequency less than a threshold data packet frequency as vacant with human absent and a corresponding human count of zero. In yet another example, the computer system accesses an occupancy template associated with a lounge that designates identification of each mobile phone with a data packet frequency greater than a threshold data packet frequency as occupied with human present and a corresponding human count of one.

Thus, the computer system can access a map of the space or an occupancy template for a particular work zone (e.g., conference room, agile work environment, hallway, lounge, reception area) within the space and link data packet frequencies of computing devices with corresponding occupancy conditions or states defined in the occupancy template to derive human occupancy and/or human count for the particular work zone.

### 12.2 Wireless Sensor Localization

Generally, the computer system can track data packet transmissions from computing devices to the population of sensor blocks and estimate approximate locations of these computing devices. The computer system can further represent these locations and computing devices within an existing two-dimensional or three-dimensional floor plan of the office space.

In one variation, during a first time period, the computer system can: access a first set of data packets detected by a first wireless sensor, in the population of wireless sensors; access a second set of data packets detected by a second wireless sensor, in the population of wireless sensors; estimate a first location of a first computing device, characterized by a device type, based on data packets transmitted by the first computing device to the first wireless sensor and the second wireless sensor; and estimate a second location of a second computing device, characterized by the device type, based on data packets transmitted by the second computing device to the first wireless sensor and the second wireless sensor. The computer system can then label the first computing device with the first location and the second computing device with the second location in an existing digital two-dimensional or three-dimensional floor plan provided by the user (e.g., administrator or manager affiliated with the office space) during installation.

The computer system can repeat these methods and techniques for each other wireless sensor in the population of wireless sensors deployed in the office space, for each other computing device transmitting data packets to the population of wireless sensors during the first time period, and for each other time period.

Thus, the computer system can monitor network traffic, track data packet transmissions, and estimate approximate locations of computing devices within the office space to populate the existing digital two-dimensional or three-dimensional map with these approximate locations to derive metrics and insights of human occupancy within the space.

### 12.3 Occupancy States+Localization Map

In one implementation, each wireless sensor can extract a set of data packets from radio signals transmitted between computing devices and the set of access points and offload these data packets to the computer system. The computer system can then: retrieve a map of the space or an occupancy template for a particular work zone; and transform the set of data packets and corresponding timestamps into a data packet frequency for each computing device in the particular work zone. Responsive to the data packet frequency falling within a target frequency range, defined in the map of the space or the occupancy template for the particular work zone, the computer system can identify the computing device in an occupied with human absent state, an occupied with human present state, a vacant state, and/or derive a human count for the particular work zone according to predefined occupancy states.

For example, the computer system can access an occupancy template for a first work zone, such as an agile desk area, in the space and defining: an occupied with human present state defining a first target frequency range for computing devices in the agile desk area; an occupied with human absent state defining a second target frequency range for computing devices in the agile desk area; and a vacant state defining a third target frequency range for computing devices in the agile desk area. At a first time, the computer system can: access a first set of data packets transmitted by a first computing device to the wireless sensor; derive a first data packet frequency of the first set of data packets transmitted by the first computing device; and, in response to the first data packet frequency falling within the first target frequency range, identify the first computing device in the occupied with human present state. Then, in response to the agile desk area encompassing a first location unit occupied by a first access point in the localization map, the computer system can update the first location unit in the localization map to indicate the first computing device in the occupied with human present state.

At a second time, the computer system can: access a second set of data packets transmitted by the first computing device to the wireless sensor; derive a second data packet frequency of the second set of data packets transmitted by the first computing device; and, in response to the second data packet frequency falling within the second target frequency range, identify the first computing device in the occupied with human present state. Then, in response to the agile desk area encompassing the first location unit occupied by the first access point, the computer system can update the first location unit in the localization map to indicate the first computing device in the occupied with human present state.

At a third time, the computer system can: access a third set of data packets transmitted by the first computing device to the wireless sensor; derive a third data packet frequency of the third set of data packets transmitted by the first computing device; and, in response to the third data packet frequency falling within the third target frequency range, identify the first computing device in the vacant state according to the third condition. Then, in response to the agile desk area encompassing the first location unit occupied by the first access point, the computer system can update the first location unit in the localization map to indicate the first computing device in the vacant state.

Additionally or alternatively, the computer system can receive a set of data packets associated with a set of (e.g., three) computing devices occupying locations within a particular work zone and update the occupancy state of each computing device within the existing two-dimensional or three-dimensional floor plan of the space. For example, the computer system can receive, from a wireless sensor: a first set of data packets transmitted by a first computing device; a second set of data packets transmitted by a second computing device; and a third set of data packets transmitted by a third computing device. The computer system can then execute Blocks of the method S100 to calculate a data packet frequency for each computing device and identify the occupancy state of the computing device. Accordingly, the computer system can update the map of the space to identify the first computing device in the occupied with human present state, the second computing device in the occupied with human absent state, and the third computing device in the vacant state within this particular work zone.

Therefore, the computer system can track data packet frequencies corresponding to target frequency ranges, defined in the map of the space or an occupancy template for a particular work zone, to identify the computing devices transmitting these data packets in an occupied with human absent state, an occupied with human present state, a vacant state and/or derive a human count for the particular work zone.

### 12.4 Device Classification Models

Generally, the computer system can: track a group of device types (e.g., laptops, mobile phones, tablets) over a period of time (e.g., one week, one month, six months) within the office space; derive and learn device classification models for common groups of each device type (e.g., laptops, mobile phones, tablets) within the office space; execute actions (e.g., generate prompts) indicating a device classification for each device in the common group of a device type; and serve these prompts to a user (e.g., administrator or manager affiliated with the office space) to confirm device classifications. More specifically, the computer system can detect patterns of common groups of device types as a function of time of day, location within the office space, data packet frequency, bandwidth, and signal strength.

In particular, patterns of common groups of device types as a function time of day can include detecting a computing device transmitting radio signals during a particular time period (e.g., desktop transmitting radio signals transmitted between 5 am and 7 am prior to work hours). The patterns of common groups of device types as a function of location within the office space can include detecting a computing device transmitting radio signals from a constant location (e.g., tablet transmitting radio signals from a lobby). The patterns of common groups of device types as a function of data packet frequency can include detecting a computing device transmitting 8 million data packets per hour or detecting a computing device transmitting 40 million data packets per hour. The patterns of common groups of device types as a function of bandwidth can include detecting a computing device transmitting radio signals over a particular bandwidth (e.g., printer transmitting radio signals over 2.4 GHz or laptop transmitting radio signals over 5 GHz). The patterns of common groups of device types as a function of signal strength can include detecting a laptop in a closed position corresponding to a static received signal strength indicator (or “RSSI”) or detecting a laptop in an open position corresponding to a dynamic (e.g., moving, active) RSSI.

Furthermore, the computer system can generate a notification indicating the common group of laptops as active and in an open position and/or as inactive and in a closed position; and prompt a user (e.g., administrator or manager affiliated with the office space) to confirm the common group of laptops as active or inactive. Accordingly, responsive to the user's confirmation that the common group of laptops is correctly identified, the computer system can reinforce the device classification model. Alternatively, responsive to the user's confirmation that the common group of laptops is incorrectly identified, the computer system can retrain and/or update the device classification model.

### 12.4.1 Active Device Classification Modeling

In one variation, the computer system can: track groups of device types (e.g., laptops, tablets, desktops, printers, mobile phones) within the office space over a period of time (e.g., one week, one month); detect a common group of a device type within the period of time (e.g., on hour, one day, one week); and derive an active device classification model for a pattern of the common group.

For example, the computer system can: receive a device list—labeled with data packets, locations, timestamps, and device identifiers of computing devices—from each wireless sensor within the office space during a particular time period (e.g., 8 AM to 9 AM); extract device identifiers from the device list to detect a common group of a device type, such as laptops, located within a first location (e.g., agile work environment) within the office space during the time period (e.g., 8 AM to 9 AM); and extract data packets from the device list to calculate a data packet frequency of each laptop in the common group of laptops during the time period. Then, in response to the data packet frequency of each laptop exceeding a threshold data packet frequency, the computer system can identify the common group of laptops as active and in an open position. The computer system can then: track the frequency of occurrence of the common group of laptops during future time periods; define a pattern based on the frequency of occurrence of the common group of laptops detected during the future time periods; and generate an active device classification model for the pattern of the common group of laptops within the office space.

Therefore, the computer system can derive active device classification models by identifying and tracking patterns of common groups of device types over a period of time. The computer system can then execute the active device classification model and the occupancy template to derive human occupancy (e.g., human presence).

### 12.4.2 Inactive Device Classification Modeling

In one variation, the computer system can: track groups of device types (e.g., laptops, tablets, desktops, printers, mobile phones) within the office space over a period of time (e.g., one week, one month); detect a common group of a device type within the period of time (e.g., one hour, one day, one week); and derive an inactive device classification model for the pattern of the common group of the device type.

For example, the computer system can: receive a device list—labeled with data packets, locations, timestamps, and device identifiers of computing devices—from each wireless sensor within the office space during a particular time period (e.g., 11 AM to 12 PM); extract device identifiers from the device list to detect a common group of a device type, such as laptops, located within the first location (e.g., agile work environment) within the office space during the time period (e.g., 11 AM to 12 PM); and extract data packets from a device list to calculate a data packet frequency of each laptop in the common group of laptops during the time period. Then, in response to the data packet frequency of each laptop falling below a threshold data packet frequency, the computer system can identify the common group of laptops as inactive and in a closed position. The computer system can then: track the frequency of the common group of laptops during future time periods; define a pattern based on the frequency of the common group of laptops detected during the future time periods; and generate an inactive device classification model for the pattern of the common group of laptops within the office space.

Therefore, the computer system can derive inactive device classification models by identifying and tracking patterns of a common group of device types over a period of time. The computer system can then execute the inactive device classification model and the occupancy template to derive human occupancy (e.g., occupied with human absent) or human vacancy (e.g., human absence).

### 12.5 User Validation of Models

In one implementation, the computer system can execute the methods and techniques described above to: detect a pattern for a common group of device types in the office space; identify a common group of laptops as active and in an open position; generate a notification indicating the common group of laptops as active and in an open position; and prompt a user to confirm the common group of laptops as active. Responsive to the user's confirmation that the common group of laptops is active and in an open position, the computer system can reinforce the active device classification model. Responsive to the user's indication that the common group of laptops is incorrectly identified, the computer system can retrain or update the active device classification model for future time periods.

In another implementation, the computer system can execute the methods and techniques described above to: detect a pattern for a common group of device types in the office space; identify a common group of laptops as inactive and in a closed position; generate a notification indicating the common group of laptops as inactive and in a closed position; and prompt a user to confirm the inactivity of the common group of laptops. Responsive to the user's indication that the common group of laptops is inactive and in a closed position, the computer system can reinforce the inactive device classification model. Responsive to the user's indication that the common group of laptops is incorrectly identified, the computer system can retrain or update the inactive device classification model for future time periods.

Therefore, the computer system can improve the active device classification model in response to an user's indication that the common group of laptops is correctly identified and/or incorrectly identified as active and in an open position. Similarly, the computer system can improve the inactive device classification model in response to an user's indication that the common group of laptops is correctly identified and/or incorrectly identified as inactive and in a closed position.

### 12.6 Occupancy Metrics and Insights

Generally, the computer system can execute the device classification model, the inactive device classification model, and access the occupancy template to derive human occupancy and insights for the space. More specifically, the computer system can: derive a set of correlations between the first computing device, the second computing device, and the occupancy conditions of the occupancy template; and derive occupancy for the space based on the set of correlations between the first computing device, the second computing device, and the occupancy conditions of the occupancy template.

In one implementation, the computer system can implement methods and techniques described above to identify a set of computing devices (e.g., tablets) within a workstation as active based on the active device classification model; identify a second set of computing devices (e.g., tablets) within the workstation as inactive based on the inactive device classification model; derive a set of correlations between the first set of computing devices, the second set of computing devices, and occupancy conditions of a corresponding occupancy policy (e.g., occupancy template) defined by an user; and derive a human count associated with the first set of computing devices and the second set of computing devices based on the set of correlations between the first set of computing devices, the second set of computing devices, and the occupancy conditions of the occupancy template.

For example, the computer system can derive a human count for a workstation within the office space and further predict presence and absence of humans (e.g., on a break in a cafeteria) for the workstation. In this example, the computer system can: identify a first tablet within a workstation as active based on the active device classification model; execute the active device classification model to identify a second tablet within the workstation as active; and execute the inactive device classification model to identify a third tablet within the workstation as inactive. The computer system can then access a first occupancy policy (e.g., occupancy template) for a workstation with an active tablet associated with a human count of one and access a second occupancy policy for a workstation with an inactive tablet associated with a human count of zero. Furthermore, the computer system can: derive correlations between the first tablet, the second tablet, and the first occupancy policy to derive a first human count of two; and derive correlations between the third tablet and the second occupancy policy to derive a second human count of zero. The computer system can then: combine the first human count and the second human count to calculate a total human count (e.g., two humans) of the workstation; generate a notification for the total human count of the workstation; and serve the notification to a user via the user portal and thus, enable the user to review accurate real-time human occupancy for the workstation within the office space.

Furthermore, the computer system can also store computing devices detected at workstations and classified as inactive by the inactive device classification model. Therefore, the computer system can provide statistics and/or other guidance on the type of computing devices that are frequently left unattended by employees at a work zone within the office space, thereby enabling the user (e.g., administrator or manager affiliated with the space) to adjust occupancy policies and/or issue advisories regarding employees' use of an work zone (e.g., workstation, conference room, cafeteria, lounge) within the office space. Alternatively, the computer system can adjust an occupancy template over time to accurately represent human occupancy of a work zone, thereby further improving predictions of occupancy metrics and insights for the office space.

### 12.6.1 Example: Laptops in a Conference Room

In one example, the computer system can implement methods and techniques described above to: detect a group of laptops in a conference room within the office space; estimate locations of this group of laptops, select an occupancy template for a conference room; and execute the active device classification model, the inactive device classification model, and the occupancy template to derive human occupancy within the conference room.

In this example, the computer system can: receive a device list labeled with data packets, locations, timestamps, and device identifiers of computing devices—from each wireless sensor, in the population of wireless sensors, deployed within a threshold distance of the conference room during a particular time period (e.g., 9 AM to 10 AM); extract device identifiers from a device list to detect a common group of laptops located in the conference room within the office space during the time period (e.g., 9 AM to 10 AM); and calculate a total quantity of laptops (e.g., 10 laptops) in the common group of laptops located in the conference room. Then, the computer system can: detect a first subset of laptops (e.g., 3 laptops) exhibiting a data packet frequency falling below the threshold data packet frequency (e.g., low data packet frequency); and execute the inactive device classification model to identify the first subset of laptops as inactive and in a closed position. The computer system can then: associate the first subset of laptops with the conference room based on a location of each laptop; select an occupancy template, in a set of occupancy templates based on the conference room; derive a set of correlations between the first subset of laptops and the set of occupancy conditions defined in the occupancy template; and interpret a human count for each laptop in the first subset of laptops (e.g., 3 laptops) associated with an absent human based on the set of correlations.

Furthermore, the computer system can: detect a second subset of laptops (e.g., 7 laptops) exhibiting a data packet frequency exceeding the threshold data packet frequency (e.g., high data packet frequency); and execute the active device classification model to identify the second subset of laptops as active and in an open position. The computer system can then: associate the second subset of laptops with the conference room according to the location of each laptop; select an occupancy template, in a set of occupancy templates associated with the conference room; derive a set of correlations between the second subset of laptops and the set of occupancy conditions defined in the occupancy template to interpret a human count for each laptop in the second subset of laptops (e.g., 7 laptops) associated with a present human. Additionally, the computer system can: derive a total human occupancy for the conference room (e.g., 7 humans present, 3 humans absent); generate a notification indicating the total human occupancy of the conference room; and serve the notification to a user (e.g., administrator or manager affiliated within the conference room) via a user portal.

Therefore, the computer system can monitor network traffic (e.g., radio signals) from computing devices via the population of wireless sensors and manipulate network traffic via the active device classification model and the inactive device classification model to identify computing devices as active and/or inactive. The computer system can then derive correlations between an occupancy template, the active device classification model, and the inactive device classification model to derive human occupancy for a work zone (e.g., conference room) within the office space. The computer system can also present human occupancy predictions to a user via the user portal and thereby enable the user to timely review human occupancy of the conference room, avoid a manual check of the conference room, and generate informed decisions regarding occupancy usage of the conference room.

The systems and methods described herein can be embodied and/or implemented at least in part as a machine configured to receive a computer-readable medium storing computer-readable instructions. The instructions can be executed by computer-executable components integrated with the application, applet, host, server, network, website, communication service, communication interface, hardware/firmware/software elements of a user computer or mobile device, wristband, smartphone, or any suitable combination thereof. Other systems and methods of the embodiment can be embodied and/or implemented at least in part as a machine configured to receive a computer-readable medium storing computer-readable instructions. The instructions can be executed by computer-executable components integrated by computer-executable components integrated with apparatuses and networks of the type described above. The computer-readable medium can be stored on any suitable computer readable media such as RAMs, ROMs, flash memory, EEPROMs, optical devices (CD or DVD), hard drives, floppy drives, or any suitable device. The computer-executable component can be a processor but any suitable dedicated hardware device can (alternatively or additionally) execute the instructions.

As a person skilled in the art will recognize from the previous detailed description and from the figures and claims, modifications and changes can be made to the embodiments of the invention without departing from the scope of this invention as defined in the following claims.

I claim:

1. A method for detecting occupancy within a space comprising:
at a first wireless sensor, detecting a set of radio signals transmitted between a set of computing devices and a set of access points arranged in the space;
for each radio signal in the set of radio signals:
extracting a source unique identifier representing an initial computing device, in the set of computing devices, from the radio signal;
extracting a unique destination identifier representing an initial access point, in the set of access points, from the radio signal; and
retrieving a set of device characteristics associated with the initial computing device from the radio signal;
storing source unique identifiers, unique destination identifiers, and sets of device characteristics, extracted from the set of radio signals, in a first set of containers; and
at a computer system:
accessing a known position of the first wireless sensor;
accessing a signal transmission range of a first access point, in the set of access points, based on the first set of containers;
deriving a first signal strength of a first radio signal, in the set of radio signals, based on the known position of the first wireless sensor and the signal transmission range of the first access point;
in response to the first signal strength exceeding a threshold signal strength, deriving a first location unit occupied by the first access point; and
defining the first location unit in a localization map representing locations of the set of access points within the space.

2. The method of claim 1:
wherein deriving the first location unit occupied by the first access point comprises deriving a first area, representing a floor within the space, occupied by the first access point; and
further comprising, at the computer system:
annotating the first area in the localization map with a first unique destination identifier and a first set of device characteristics stored in the first set of containers;
receiving a second unique destination identifier representing a destination access point;
scanning the localization map for the second unique destination identifier; and
in response to detecting the first unique identifier analogous to the second unique destination identifier:
identifying the first access point as the destination access point within the localization map;
annotating the first area representing the floor within the space with the second unique destination identifier;
highlighting a representation of the first area and the destination access point in the localization map; and
serving the localization map to a user.

3. The method of claim 1, further comprising:
accessing an occupied with human present state defining a first target frequency range for computing devices in a first work zone in the space;
accessing a first set of data packets, transmitted by a first computing device, to a population of wireless sensors comprising the first wireless sensor, at a first time;
calculating a first data packet frequency of the first set of data packets transmitted by the first computing device;
in response to the first data packet frequency falling within the first target frequency range, associating the first computing device with the occupied with human present state; and
in response to the first work zone encompassing the first location unit, updating the first location unit in the localization map to indicate the first computing device in the occupied with human present state.

4. The method of claim 3:
further comprising:
accessing an occupied with human absent state defining a second target frequency range for computing devices in the first work zone;
accessing a second set of data packets transmitted by the first computing device to the population of wireless sensors at a second time;
calculating a second data packet frequency of the second set of data packets transmitted by the first computing device; and
in response to the second data packet frequency falling within the second target frequency range, associating the first computing device with the occupied with human absent state; and
wherein updating the first location unit in the localization map comprises, in response to the first work zone encompassing the first location unit, updating the first location unit in the localization map to indicate the first computing device in the occupied with human absent state.

5. The method of claim 3:
further comprising, at the computer system:
accessing a vacant state defining a second target frequency range for computing devices in the first work zone;
accessing a second set of data packets transmitted by the first computing device to the population of wireless sensors at a second time;
calculating a second data packet frequency of the second set of data packets transmitted by the first computing device; and
in response to the second data packet frequency falling within the second target frequency range, associating the first computing device with the vacant state; and
wherein updating the first location unit in the localization map to indicate the first computing device in the occupied with human present state comprises, in response to the first work zone encompassing the first location unit, updating the first location unit in the localization map to indicate the first computing device in the vacant state.

6. The method of claim 3:
wherein accessing the occupied with human present state comprises accessing the occupied with human present state defining the first target frequency range for computing devices in the first work zone, comprising an agile desk area, in the space location within a building; and
wherein updating the first location unit in the localization map comprises, in response to the agile desk area encompassing the first location unit comprising a floor level of the building, updating a representation of the floor level in the localization map to indicate the first computing device in the occupied with human present state.

7. The method of claim 1:
further comprising:
receiving an activation data packet, generated by the first wireless sensor, annotated with an initial position; and
accessing a map of the space annotated with target signal transmission ranges associated with the set of access points;
wherein accessing the known position of the first wireless sensor comprises deriving the initial position of the first wireless sensor from the activation data packet;
wherein deriving the first signal strength of the first radio signal comprises deriving the first signal strength of the first radio signal based on the initial position of the first wireless sensor and the signal transmission range of the first access point; and
wherein deriving the first location unit occupied by the first access point comprises deriving the first location unit occupied by the first access point:
in response to the first signal strength exceeding the threshold signal strength; and
in response to the signal transmission range corresponding to a target signal transmission range associated with the first access point.

8. The method of claim 1:
wherein detecting the set of radio signals transmitted between the set of computing devices and the set of access points comprises detecting a set of reference signals transmitted between the set of computing devices and the set of access points within a threshold distance of the first wireless sensor; and
further comprising:
for each reference signal in the set of reference signals:
recording a transmit duration for the reference signal between a first computing device and a second access point; and
recording a receive duration for the reference signal between the first computing device and the second access point;
storing transmit durations and receive durations of the set of reference signals in a second set of containers;
transforming a first transmit duration and a first receive duration for a first reference signal, in the set of reference signals, into a first distance between the first computing device and the second access point based on the second set of containers;
deriving a second signal strength based on the first distance;
accessing a second signal transmission range of the second access point; and
predicting a second location unit occupied by the second access point based on the second signal strength and the second signal transmission range.

9. The method of claim 8:
wherein predicting the second location unit occupied by the second access point comprises:
in response to the second signal strength falling below a threshold signal strength, isolating a second reference signal, in the set of reference signals;
extracting a second transmit duration for the second reference signal between the first computing device and the second access point from the second set of containers; and
extracting a second receive duration for the reference signal between the first computing device and the second access point from the second set of containers; and
further comprising:
transforming the second transmit duration and the second receive duration for the second reference signal into a second distance between the first computing device and the second access point;
deriving a third signal strength inversely proportional to the second distance; and
predicting a third location unit occupied by the second access point based on the third signal strength and the second signal transmission range:
in response to the third signal strength exceeding the threshold signal strength; and
in response to the second signal transmission range corresponding to a target signal transmission range.

10. The method of claim 8:
wherein detecting the set of radio signals transmitted between the set of computing devices and the set of access points comprises detecting the set of radio signals transmitted between the set of computing devices and the set of access points arranged in the space comprising an agile work environment; and
wherein predicting the second location unit occupied by the second access point comprises predicting the second location unit, comprising an area representing a floor level within the agile work environment, occupied by the second access point:
in response to the second signal strength exceeding a threshold signal strength; and
in response to the signal transmission range corresponding to a target signal transmission range.

11. The method of claim 1:
further comprising:
receiving an activation data packet, generated by the first wireless sensor, annotated with an initial position of the first wireless sensor, a timestamp of activation, and an initial unique identifier associated with the first wireless sensor; and
compiling the activation data packet into an activation database ranked by timestamps, the activation database representing activation of a population of wireless sensors comprising the first wireless sensor;
wherein accessing the known position of the first wireless sensor comprises:
extracting a first unique identifier representing the first wireless sensor from the set of radio signals; and
in response to the first unique identifier corresponding to the initial unique identifier in the activation database, retrieving the initial position of the first wireless sensor from the activation data packet; and
wherein deriving the first signal strength of the first radio signal comprises deriving the first signal strength of the first radio signal based on the initial position and the signal transmission range.

12. The method of claim 1:
wherein detecting the set of radio signals transmitted between the set of computing devices and the set of access points comprises detecting the set of radio signals transmitted between the set of computing devices and the set of access points arranged in the space comprising an agile work environment;
wherein deriving the first location unit occupied by the first access point comprises, in response to the first signal strength exceeding the threshold signal strength, deriving the first location unit occupied by the first access point associated with a unique destination identifier comprising a conference room identifier; and
wherein defining the first location unit in the localization map comprises writing the conference room identifier to the localization map representing locations of the set of access points within the agile work environment.

13. The method of claim 1, wherein defining the first location unit in the localization map comprises:
retrieving a floor plan of the space annotated with known location units and target signal transmission geometries;
isolating a known location unit corresponding to an agile desk area in the floor plan of the space; and
populating the agile desk area, represented in the floor plan of the space, with the first location unit to generate the localization map:
in response to the first location unit corresponding to the known location unit in the floor plan of the space; and
in response to the first signal transmission range corresponding to a target signal transmission range associated with the agile desk area.

14. The method of claim 1:
wherein detecting the set of radio signals transmitted between the set of computing devices and the set of access points comprises detecting the set of radio signals, comprising a set of data packets, transmitted between the set of computing devices and the set of access points;
further comprising:
accessing an occupied with human absent state, defining a first target frequency range for computing devices in a first work zone in the space, associated with a known human count;
extracting a first subset of data packets, in the set of data packets, transmitted by the first computing device to a population of wireless sensors comprising the first wireless sensor, at a first time;
calculating a first data packet frequency of the first subset of data packets transmitted by the first computing device; and
in response to the first data packet frequency falling within the first target frequency range:
identifying the first computing device within the first work zone in the occupied with human absent state; and
deriving a human count for the first work zone according to the known human count; and
wherein defining the first location unit in the localization map comprises writing the human count to the first location unit in the localization map representing locations of the set of access points in the first work zone in the space.

15. A method for detecting occupancy within a space comprising:
at a first wireless sensor:
detecting a first set of data packets transmitted by a first computing device; and
detecting a second set of data packets transmitted by a second computing device;
retrieving a map of the space;
accessing an occupied with human present state annotated with a first target frequency range for computing devices in a first work zone;
accessing an occupied with human absent state annotated with a second target frequency range for computing devices in the first work zone;
calculating a first data packet frequency of the first set of data packets transmitted by the first computing device;
in response to the first data packet frequency falling within the first target frequency range, associating the first computing device with the occupied with human present state;
calculating a second data packet frequency of the second set of data packets transmitted by the second computing device;
in response to the second data packet frequency falling within the second target frequency range, associating the second computing device with the occupied with human absent state; and
updating the map of the space to indicate the first computing device in the occupied with human present state and the second computing device in the occupied with human absent state within the first work zone.

16. The method of claim 15:
further comprising:
at the wireless sensor, detecting a third set of data packets transmitted by a third computing device;
accessing a vacant state associated with a third target frequency range for computing devices in the first work zone;
calculating a third data packet frequency of the third set of data packets transmitted by the third computing device; and
in response to the third data packet frequency falling within the third target frequency range, associating the third computing device with the vacant state; and
wherein updating the map of the space comprises updating the map of the space to indicate the first computing device in the occupied with human present state, the second computing device in the occupied with human absent state, and the third computing device in the vacant state within the first work zone.

17. The method of claim 15:
further comprising, at the first wireless sensor:
detecting a set of radio signals transmitted between a set of computing devices and a set of access points arranged in the space, the set of computing devices comprising the first computing device and the second computing device;
for each radio signal in the set of radio signals:
extracting a source unique identifier representing the first computing device from the radio signal;
extracting a unique destination identifier representing an initial access point, in the set of access points, from the radio signal; and
retrieving a set of device characteristics associated with the first computing device from the radio signal;
storing source unique identifiers, unique destination identifiers, and sets of device characteristics of the set of access points in a first set of containers;
accessing a first signal strength of a first radio signal, in the set of radio signals; and
in response to the first signal strength exceeding a threshold signal strength, deriving a first location unit occupied by the first access point; and
wherein updating the map of the space comprises, in response to the first work zone encompassing the first location unit, populating the first work zone in the map with the first location unit occupied by the first access point.

18. The method of claim 17:
wherein deriving the first location unit occupied by the first access point comprises deriving a first area, representing a room within the space, occupied by the first access point;
further comprising defining the first area in a localization map representing locations of the set of access points within the space; and
wherein updating the map of the space comprises, in response to the first work zone encompassing the first area, populating the first work zone in the map with the first location area occupied by the first access point.

19. A method for detecting occupancy within a space comprising:
at a wireless sensor:
detecting a set of radio signals transmitted between a set of computing devices and a set of access points deployed throughout the space;
for each radio signal in the set of radio signals:
extracting a first unique identifier representing an initial computing device, in the set of computing devices, from the radio signal; and
extracting a second unique identifier representing an initial access point, in the set of access points, from the radio signal;
associating unique identifiers of the set of access points with the set of computing devices in a first set of containers;
accessing a known position of the wireless sensor;
calculating a first signal transmission range of a first access point, in the set of access points, based on the first set of containers;
deriving a first signal strength of a first radio signal, in the set of radio signals, based on the known position and the first signal transmission range; and
in response to the first signal strength exceeding a threshold signal strength:
deriving a first location unit occupied by the first access point; and
defining the first location unit in a localization map representing locations of the set of access points within the space.

20. The method of claim 19:
further comprising, at the wireless sensor, for each radio signal in the set of radio signals, retrieving an initial set of device characteristics associated with the initial computing device from the radio signal;
wherein associating unique identifiers of the set of access points with the set of computing devices comprises associating unique identifiers of the set of access points and sets of device characteristics, extracted from the set of radio signals, with the set of computing devices in the first set of containers; and
further comprising annotating the first location unit in the localization map with the second unique identifier and a first set of device characteristics associated with the first computing device.
